(19) United States
(12) Patent Application Publication
(10) Pub. No.: US 2007/0127462 A1
(43) Pub. Date: Jun. 7, 2007

(54) Method of operating communication terminal managing channel conversion error of program of digital multimedia broadcasting contents and communication terminal enabling the method

(75) Inventor: Jin Young Kim, Seoul (KR)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: PANTECH CO., LTD.

(21) Appl. No.: 11/493,066

(22) Filed: Jul. 26, 2006

(30) Foreign Application Priority Data
Dec. 2, 2005 (KR) 10-2005-00116781

(51) Int. Cl. H04L 12/56

(52) U.S. Cl. 370/389; 714/748; 725/62; 348/385.1

(57) ABSTRACT

A method of operating a communication terminal managing a channel conversion error of a program with respect to a digital multimedia broadcasting (DMB) content and a communication terminal employing the method. More particularly, a method of operating a communication terminal managing a channel conversion error of a program with respect to a DMB content receiving a normal pilot table by determining an error of a pilot table received from a code-division multiplexing (CDM) chip through a predetermined process, and the communication terminal employing the method are provided. Accordingly, when a communication terminal receives a pilot table through a CDM chip, the communication terminal determines whether two pilot tables are identical by serially receiving the two pilot tables. When the pilot tables are identical, the communication terminal may prevent an error from occurring in the pilot table by recording in a predetermined pilot table storage unit.

### CROSS-REFERENCE TO RELATED APPLICATION

This application claims the benefit of Korean Patent Application No. 10-2005-00116781, filed on Dec. 2, 2005, in the Korean Intellectual Property Office, the disclosure of which is incorporated herein by reference.

### BACKGROUND OF THE INVENTION

1. Field of the Invention

The present invention relates to a method of operating a communication terminal managing a channel conversion error of a program with respect to a digital multimedia broadcasting (DMB) content and a communication terminal employing the method, and more particularly, to a method of operating a communication terminal managing a channel conversion error of a program with respect to a DMB content receiving a normal pilot table by determining an error of a pilot table received from a code-division multiplexing (CDM) chip through a predetermined process and a communication terminal employing the method.

2. Description of Related Art

Currently, incredible developments of communication technologies rapidly accelerate the popularization of a communication terminal, e.g. a portable device. Also, most people always carry a communication terminal such as a mobile phone and a personal digital assistant (PDA).

As communication technologies develop and a large number of users utilize a communication terminal, the communication terminal provides basic services such as a phone call with another person and a short message service, and also provides other various services such as a reception of digital multimedia broadcasting (DMB), an alarm, a game, wireless Internet access, a photographing function, and an ability to play Moving Picture Experts Group (MPEG) Audio-Layer 3 (MP3) formatted music. Also, a DMB broadcasting service in which a broadcasting and a communication are combined with each other is provided by the communication terminal. In this instance, the digital broadcasting service is a digital broadcasting service providing a sound quality level of a Compact Disc (CD) and a moving picture service providing a quality level of a Digital Versatile Disc (DVD) while in motion or on a fixed location utilizing a communication terminal such as a mobile phone and a PDA, by converting multimedia data into a digital signal.

Packets such as a DMB content and a pilot table are generally received from a code-division multiplexing(CDM) chip included in a communication terminal. When packets are received from the CDM chip of the communication terminal while the communication terminal is moving, an error rate is increased. A pilot channel, which is one of the packets received from the CDM chip, includes a range value of a CDM channel allocated corresponding to a channel of a program with respect to the DMB content. When changing the channel of the program in the communication terminal, the channel is changed by referring to the pilot table. However, when there is an error in the pilot channel received from the CDM chip, the channel of the program may not be changed. Also, it is necessary to wait until a normal pilot table is received, so as to change the channel. Therefore, a method of operating a communication terminal managing a channel conversion error of a program with respect to a DMB content, which may prevent an error from occurring in a pilot table and a communication terminal enabling the method is required.

### BRIEF SUMMARY

The present invention provides a method of operating a communication terminal managing a channel conversion error of a program with respect to a DMB content, which may prevent an error from occurring in a pilot table by serially receiving two pilot tables and determining whether the received two pilot tables are identical, when the communication terminal receives the pilot table through a CDM chip, and recording the pilot table in a predetermined pilot table storage unit when the pilot tables are identical, and a communication terminal employing the method.

According to an aspect of the present invention, there is provided a method of operating a communication terminal managing a channel conversion error of a program with respect to a digital multimedia broadcasting (DMB) content, the method including: maintaining a pilot table storage unit recording a pilot table, the pilot table including a range value of a code-division multiplexing (CDM) channel allocated corresponding to a channel of the program; serially receiving a first pilot table through a CDM chip and recording the received first pilot table in a first storage unit; serially receiving a second pilot table through the CDM chip and recording the received second pilot table in a second storage unit; determining whether the first pilot table recorded in the first storage unit is identical to the second pilot table recorded in the second storage unit, whenever a new pilot table is recorded in the first storage unit and the second storage unit; and determining that there is no error in the first pilot table and the second pilot table when the first pilot table is identical to the second pilot table as a result of the determination, and updating any one of the first pilot table and the second pilot table and recording the updated pilot table in the pilot table storage unit after the determination.

According to another aspect of the present invention, there is provided a communication of terminal managing a channel conversion error of a program with respect to a DMB content, the communication terminal including: a pilot table storage unit recording a pilot table, the pilot table including a range values of a CDM channel allocated corresponding to a channel of the program; a pilot table receiving unit receiving a first pilot table through a CDM chip; a pilot table recording unit recording the received first pilot table in a first storage unit, receiving a second pilot table from the pilot table receiving unit through the CDM chip, and recording the received second pilot table in a second storage unit; and a pilot table error management unit determining whether the first pilot table recorded in the first storage unit is identical to the second pilot table recorded in the second storage unit and, when the first pilot table is identical to the second pilot table, determining that there is no error in the pilot table, and updating any one of the first pilot table and the second pilot table and recording the updated pilot table in the pilot table storage unit.

The communication terminal used throughout the present invention includes a computer terminal, a public switched telephone network (PSTN) terminal, a voice over Internet protocol (VoIP) terminal, a session initiation protocol (SIP) terminal, a media gateway control (Megaco) terminal, a personal digital assistant (PDA), a mobile phone, a personal communication service (PCS) phone, a hand-held personal computer (hand-held PC), a code-division multiple access (CDMA)-2000 (1X, 3X) phone, a wideband code-division multiple access (wideband CDMA) phone, a dual band/dual mode phone, a Global System for Mobile Communication (GSM) phone, a mobile broadband system (MBS) phone, or a satellite/terrestrial digital multimedia broadcasting (DMB) phone, and the like.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a flowchart illustrating a method of operating a communication terminal according to an embodiment of the present invention;

FIG. 2 is a flowchart illustrating a method of determining whether version information included in pilot tables are identical according to an embodiment of the present invention; and

FIG. 3 is a diagram illustrating an internal configuration of a communication terminal according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

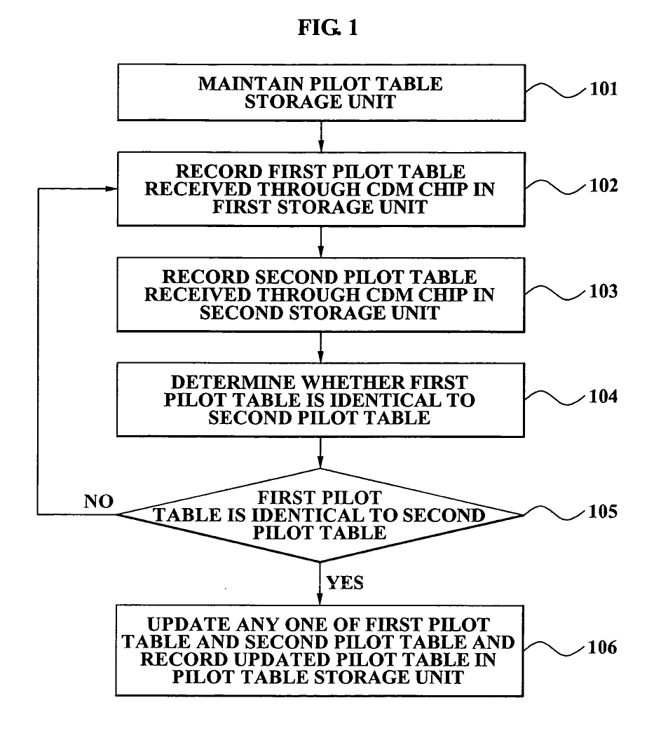

FIG. 1 is a flowchart illustrating a method of operating a communication terminal according to an embodiment of the present invention.

In operation 101, the communication terminal maintains a pilot table storage unit recording a pilot table. The pilot table includes a range value of a code-division multiplexing (CDM) channel allocated corresponding to a channel of a program. Also, the pilot table further includes version information.

In operation 102, the communication terminal receives a first pilot table through a CDM chip and records the received first pilot table in a first storage unit. The pilot table is received for each predetermined period through the CDM chip.

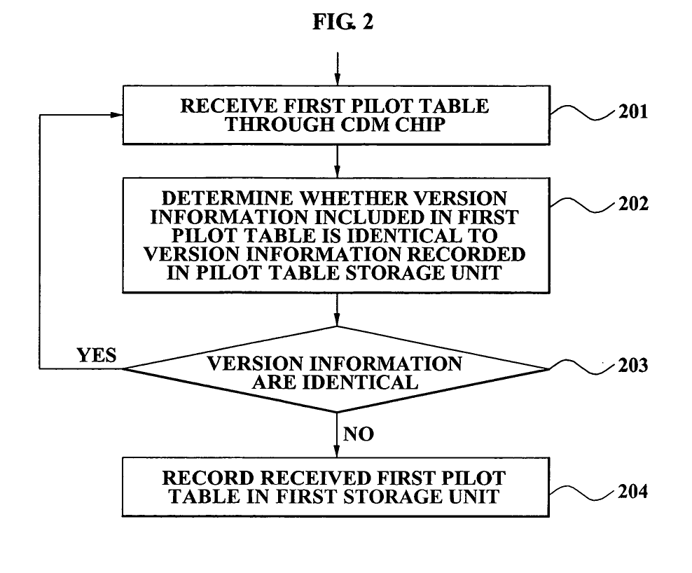

The operation 102 will be further described in detail with reference to FIG. 2.

FIG. 2 is a flowchart illustrating a method of determining whether version information included in the pilot tables are identical, according to an embodiment of the present invention.

In operation 201, the communication terminal receives the first pilot table through the CDM chip.

In operation 202, the communication terminal determines whether version information included in the received first pilot table is identical to version information of the pilot table recorded in the pilot table storage unit. Namely, in the present operation, it is determined whether the received pilot table is not identical to the pilot table recorded in the pilot table storage unit.

As a result of the determination, when the version information of the first pilot table is not identical to the version information of the pilot table recorded in the pilot table storage unit in operation 203, the communication terminal records the received first pilot table in the first storage unit in operation 204.

As a result of the determination, when the version information of the first pilot table is identical to the version information of the pilot table recorded in the pilot table storage unit in operation 204, the communication terminal maintains the pilot table recorded in the pilot table storage unit. Also, the communication terminal repeats the operations 201 and 202.

Referring to FIG. 1, in operation 103, the communication terminal receives a second pilot table through the CDM chip and records the received second pilot table in a second storage unit. According to an embodiment of the present invention, the first pilot table or the second pilot table is the pilot table serially received through the CDM chip.

In operation 104, whenever a new pilot table is recorded in the first storage unit and the second storage unit, the communication terminal determines whether the first pilot table recorded in the first storage unit is identical to the second pilot table recorded in the second storage unit.

When the first pilot table is identical to the second pilot table in operation 105, the communication terminal determines that there is no error in the first pilot table and the second pilot table. Also, the communication terminal updates any one of the first pilot table and the second pilot table and records the updated pilot table in the pilot table storage unit, according to the determination in operation 106.

According to an embodiment of the present invention, when the first pilot table is not identical to the second pilot table in operation 105, the communication terminal determines that there is an error in the first pilot table and the second pilot table. Also, the communication terminal may repeat the operation 102 through the operation 104.

According to another embodiment of the present invention, when a request for a DMB content including a channel of a predetermined program is received, the communication terminal extracts range values of a CDM channel allocated corresponding to the channel of the program by referring to the pilot table recorded in the pilot table storage unit.

As an example, when the request for the DMB content including a channel “CH 14” is received, the communication terminal may extract the range values of the CDM channel allocated corresponding to the channel “CH 14” by referring to the pilot table recorded in the pilot table storage unit. The communication terminal receives the DMB content through the extracted range values of the CDM channel and displays the received DMB content on a predetermined display unit.

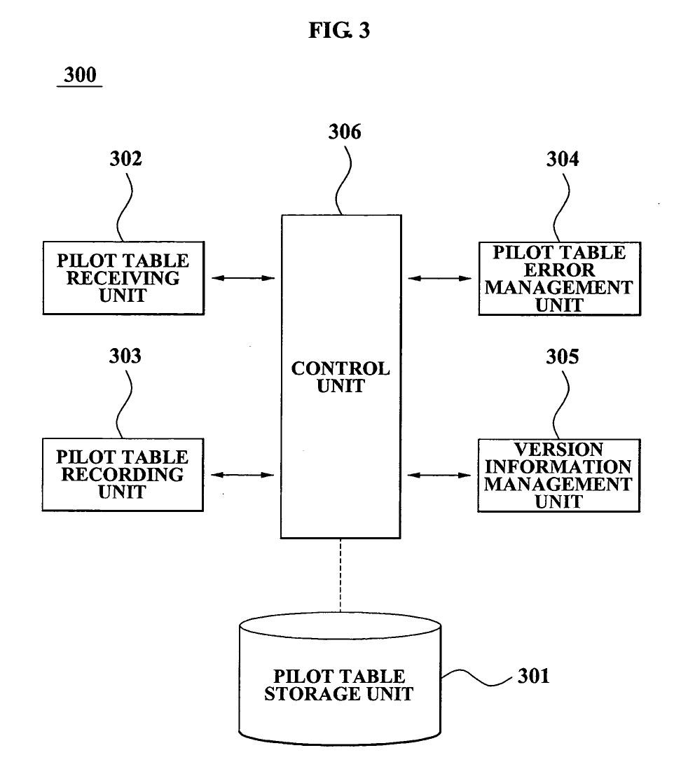

FIG. 3 is a diagram illustrating an internal configuration of a communication terminal 300 according to an embodiment of the present invention.

As illustrated in FIG. 3, the communication terminal 300 includes a pilot table storage unit 301, a pilot table receiving unit 302, a pilot table recording unit 303, a pilot table error management unit 304, a version information management unit 305, and a control unit 306.

The pilot table storage unit 301 records a pilot table. The pilot table includes the range values of a CDM channel allocated corresponding to a channel of a program. Also, the pilot table further includes version information.

The pilot table receiving unit 302 receives a first pilot table through a CDM chip. The pilot table recording unit 303 records the received first pilot table in a first storage unit. Also, the pilot table receiving unit 302 receives a second pilot table through the CDM chip. The pilot table recording unit 303 records the received second pilot table in a second storage unit. The first pilot table or the second pilot table is the pilot table serially received through the CDM chip according to an embodiment of the present invention. The pilot table is received at predetermined periods through the CDM chip.

The pilot table error management unit 304 determines whether the first pilot table recorded in the first storage unit is identical to the second pilot table recorded in the second storage unit. When the first pilot table is identical to the second pilot table, the pilot table error management unit 304 determines that there is no error in the pilot table. Also, the pilot table error management unit 304 updates any one of the first pilot table and the second pilot table in the pilot table storage unit 301.

According to an embodiment of the present invention, the version information management unit 305 determines whether the version information included in the first pilot table that the pilot table receiving unit 302 receives is identical to the version information of the pilot table recorded in the pilot table storage unit. When the version information are not identical, the pilot table recording unit 303 records the received first pilot table in the first storage unit.

The control unit 306 generally includes a processor function processing all types of data for terminal devices utilizing a modem digital signal processor (DSP). The control unit 306 may improve processing speed as more DSPs are provided for processing an internal signal such as a baseband signal. The control unit 306 may include a mobile station modem (MSM), a digital signal processor (DSP), an open multimedia application platform (OMAP), and the like.

The method of operating a communication terminal according to the above-described embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, when a communication terminal receives pilot tables through a CDM chip, the communication terminal determines whether two pilot tables are identical by using two serially received pilot tables. When the serially received pilot tables are identical, the communication terminal may prevent an error from occurring in the pilot table by recording pilot tables in a predetermined pilot table storage unit.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of operating a communication terminal managing a channel conversion error of a program with respect to a digital multimedia broadcasting (DMB) content, the method comprising:
maintaining a pilot table storage unit recording a pilot table, the pilot table including a range value of a code-division multiplexing (CDM) channel allocated corresponding to a channel of the program;
serially receiving a first pilot table through a CDM chip and recording the received first pilot table in a first storage unit;
serially receiving a second pilot table through the CDM chip and recording the received second pilot table in a second storage unit;
determining whether the first pilot table recorded in the first storage unit is identical to the second pilot table recorded in the second storage unit, whenever a new pilot table is recorded in the first storage unit and the second storage unit; and
determining that there is no error in the first pilot table and the second pilot table when the first pilot table is identical to the second pilot table, and updating any one of the first pilot table and the second pilot table and recording the updated pilot table in the pilot table storage unit according to the determination.

2. The method of claim 1, wherein:
the pilot table includes version information, and
the receiving of the first pilot table and the recording of the received first pilot table further comprises:
receiving the first pilot table through the CDM chip and determining whether the version information included in the received first pilot table is identical to the version information of the pilot table recorded in the pilot table storage unit; and
recording the received first pilot table in the first storage unit, when the version information are different as a result of the determination.

3. The method of claim 1, wherein it is determined that there is an error in the pilot table when the first pilot table is not identical to the second pilot table, and the receiving of the first pilot table and recording of the received first pilot table, the receiving of the second pilot table and recording of the received second pilot table, and the determining whether the first pilot table is identical to the second pilot table is repeated.

4. The method of claim 1, wherein the receiving of the pilot table receives the pilot table for each predetermined period through the CDM chip.

5. The method of claim 1, further comprising:
extracting the range value of the CDM channel allocated corresponding to the channel of the program by referring to the pilot table recorded in the pilot table storage unit, when a request for the DMB content including a channel of a predetermined program is received from a user, and displaying the DMB content received through the extracted range value of the CDM channel on a predetermined display unit.

6. A computer-readable recording medium storing a program for implementing the method of operating a communication terminal managing a channel conversion error of a program with respect to a digital multimedia broadcasting (DMB) content, the method comprising:
maintaining a pilot table storage unit recording a pilot table, the pilot table including a range value of a CDM channel allocated corresponding to a channel of the program;
serially receiving a first pilot table through a CDM chip and recording the received first pilot table in a first storage unit;
serially receiving a second pilot table through the CDM chip and recording the received second pilot table in a second storage unit;
determining whether the first pilot table recorded in the first storage unit is identical to the second pilot table recorded in the second storage unit, whenever a new pilot table is recorded in the first storage unit and the second storage unit; and
determining that there is no error in the first pilot table and the second pilot table when the first pilot table is identical to the second pilot table as a result of the determination, and updating any one of the first pilot table and the second pilot table and recording the updated pilot table in the pilot table storage unit according to the determination.

7. A communication terminal managing a channel conversion error of a program with respect to a DMB content, the communication terminal comprising:
a pilot table storage unit recording a pilot table, the pilot table including a range values of a CDM channel allocated corresponding to a channel of the program;
a pilot table receiving unit receiving a first pilot table through a CDM chip;
a pilot table recording unit recording the received first pilot table in a first storage unit, receiving a second pilot table from the pilot table receiving unit through the CDM chip, and recording the received second pilot table in a second storage unit; and
a pilot table error management unit determining whether the first pilot table recorded in the first storage unit is identical to the second pilot table recorded in the second storage unit and, when the first pilot table is identical to the second pilot table, determining that there is no error in the pilot table, and updating any one of the first pilot table and the second pilot table and recording the updated pilot table in the pilot table storage unit according to the determination.

8. The communication terminal of claim 7, wherein:
the pilot table includes version information, and
the communication terminal further comprises:
a version information management unit determining whether the version information included in the received first pilot table is identical to the version information of the pilot table recorded in the pilot table storage unit, and
the pilot table recording unit records the received first pilot table in the first storage unit when the version information are different as a result of the determination, receives the second pilot table through the CDM chip from the pilot table receiving unit, and records the received second pilot table in the second storage unit.

9. The communication terminal of claim 7, wherein the pilot table receiving unit receives the pilot table for each predetermined periods through the CDM chip.
